(19) United States
(12) Patent Application Publication
(10) Pub. No.: US 2010/0282882 A1
(43) Pub. Date: Nov. 11, 2010

(54) MOBILE WOOD CHIPPER

(76) Inventor: Les Zeller, Spruce Grove (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/463,332

(22) Filed: May 8, 2009

(30) Foreign Application Priority Data
May 8, 2009 (CA) 2665584

(51) Int. Cl. B27L 11/00; A01G 3/00

(52) U.S. Cl. 241/101.74; 241/285.1

(57) ABSTRACT

A mobile wood chipper a vehicle having a longitudinal axis and ground engaging wheels. A rotary bearing is supported by the vehicle and a wood chipper mounted to the rotary bearing for rotation about a substantially vertical axis between an axially oriented travel position and an off-axis operative position. A grapple arm is supported by the vehicle, the grapple arm being capable of feeding logs into the wood chipper when the wood chipper is positioned in the off-axis operative position.

### FIELD

The present invention relates to a mobile wood chipper.

### BACKGROUND

Mobile wood chippers usually mounted on vehicles, such as a trailer. The vehicles, on which the wood chippers are fixedly mounted, move to or are hauled to a remote worksite. A log forwarder machine is used to pick up logs and feed them into the mobile wood chipper.

### SUMMARY

There is provided a mobile wood chipper which includes a vehicle having a longitudinal axis and ground engaging wheels. A rotary bearing is supported by the vehicle, and a wood chipper is rotatably mounted to the rotary bearing for rotation about a substantially vertical axis between an axially oriented travel position and an off-axis operative position. A grapple arm is supported by the vehicle, the grapple arm being capable of feeding logs into the wood chipper when the wood chipper is positioned in the off-axis operative position.

The mobile wood chipper may include means for locking the wood chipper at various degrees of rotation between an axially oriented travel position and an off-axis operative position. This prevents the wood chipper from rotating away from a suitable operative position in the event that the grapple arm or a log grasped by the grapple arm inadvertently contacts the wood chipper.

The wood chipper may be capable of rotating 360 degrees increasing the number of possible operative positions. As will be hereinafter described below, this decreases the number times that the vehicle must be re-positioned in order to receive logs and allows the vehicle to operate in confined areas where re-positioning of the vehicle is impracticable.

The wood chipper may include means for rotating the wood chipper. These means may include the use of a hydraulic motor or using the grapple arm to rotate the wood chipper.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a mobile wood chipper.

### DETAILED DESCRIPTION OF THE DRAWINGS

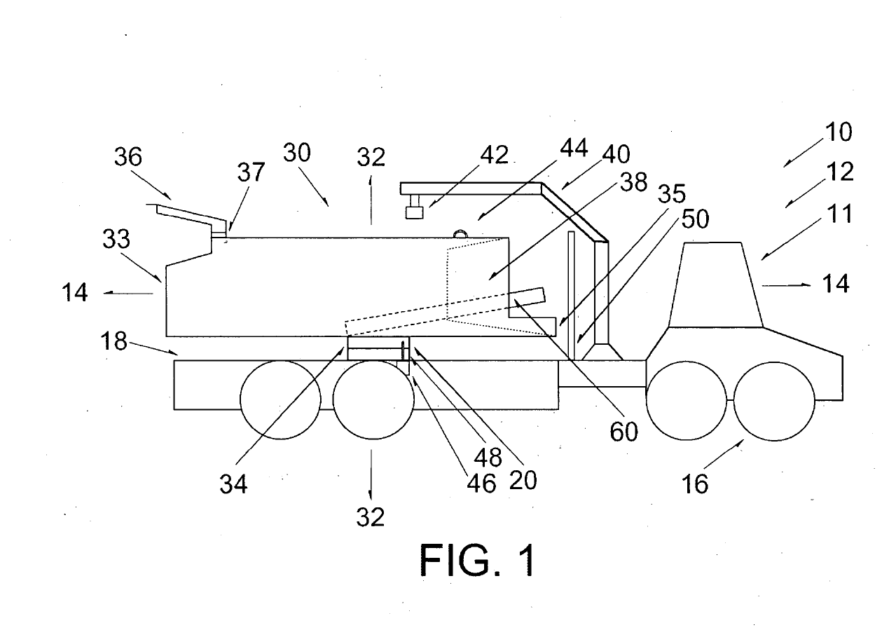

A mobile wood chipper generally identified by reference numeral 10, will now be described with reference to FIG. 1.

### Structure and Relationship of Parts:

Referring to FIG. 1, the mobile wood chipper 10 includes a vehicle 12 having a longitudinal axis 14, ground engaging wheels 16, a cab 11 and a vehicle bed 18. A rotary bearing 20 is supported by the vehicle bed 18.

A wood chipper 30 having a first end 33 and second end 35 is rotatably mounted to the rotary bearing 20 for rotation about a substantially vertical axis 32 between an axially oriented travel position and an off-axis operative position. The wood chipper 30 further includes a chip discharge chute 36 proximate the first end 33 having a 360 degree swivel 37 and a feeder entry 38 substantially aligned with longitudinal axis 14 and proximate the second end 35. The wood chipper 30 and rotary bearing 20 are positioned on vehicle bed 18 such that the wood chipper 30 is capable of rotating 360 degrees.

A grapple arm 40 includes a grapple 42 proximate the free end of grapple arm 40 is supported by the vehicle 12. The grapple arm 40 is capable of feeding logs (such as log 60) into the wood chipper 30 when the wood chipper 30 is positioned in the off-axis operative position.

Wood chipper 30 may be rotated by various means. For example, as shown, grapple 42 on arm 40 grips a loop of stiff cable 44 or a bracket on top of chipper 30 that is offset from vertical axis 32, which allows the position to be controlled by grapple arm 40. Alternatively, it may be moved by a motor connected to bearing 20. For example, a hydraulic swivel motor may be provided with a ROTEC™ bearing, where the motor turns a gear that engages a ring gear to cause chipper 30 to rotate when activated.

A locking mechanism 34 within rotary bearing 20 of a variety widely known in the art provides means for locking the wood chipper at various degrees of rotation between an axially oriented travel position and an off-axis operative position. In the depicted embodiment, a solenoid 46 on rotary bearing 20 causes a pin 48 to move upward and engage a selected hole 52 in rotary bearing 20. A series of holes are provided in rotary bearing 20 that correspond to preselected position, such that wood chipper 30 is rotated until the selected position is reached, at which point solenoid 46 is actuated to lock rotary bearing 20 in position. Pin 48 is then withdrawn in order to unlock the position.

For the protection of an operator in cab 11, a safety panel 50 is mounted between the cab 11 and the wood chipper 30.

### Operation:

It is common practice in the logging industry to use a wood chipper fixedly mounted to a vehicle and a separate loader machine to pick up logs and feed them into the wood chipper. The loader machine is kept separate from the wood chipper because the re-orientation of logs so as to be receivable by the wood chipper requires a large working space. It is also typically necessary to adjust the position of the wood chipper by moving it (and the entire vehicle on which it is fixedly mounted) relative to the position of the log forwarder so as to increase working space. The presence of trees and forest debris at a typical worksite serves to compound the problem of a confined working space.

It will become apparent from the following description of the operation of the present invention that the confined working space problem is lessened by the rotatability of wood chipper 30 and the integration of the grapple arm 40 on to the vehicle 12. Owing to the fact that only one vehicle 12 is required to instead of two to complete chipping of logs at a worksite, the mobile wood chipper 10 can be used at smaller worksites. Furthermore, due to the rotatability of wood chipper 30, instances requiring repositioning of vehicle 12 to allow for receiving of log 60, is greatly reduced.

The mobile wood chipper 10 moves to a worksite in an axially oriented travel position. Upon arrival, the mobile wood chipper 10 is stationed such that logs are within the reach of grapple arm 40. Grapple arm 40 grapples a log 60 (shown already inserted into feeder entry 38) and orients the log such that the log is readily received by feeder entry 38. Where the orientation of log 60 by grapple arm 40 is insufficient to render log 60 readily receivable by feeder entry 38, wood chipper 30 is rotated by either grapple arm 40 as shown, or by a hydraulic motor widely known in the art and locked such that feeder entry 38 readily receives the log 60. The capability of wood chipper 30 to rotate 360 degrees greatly enhances the ability of grapple arm 40 and wood chipper 30 to move conjunctively so as to orient log 60 such that the feeder entry 38 readily receives log 60. Finally, wood chipper 30 processes log 60 and wood chips exit the chip discharge chute 36.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A mobile wood chipper, comprising:
a vehicle having a longitudinal axis and ground engaging wheels;
a rotary bearing supported by the vehicle;
a wood chipper mounted to the rotary bearing for rotation about a substantially vertical axis between an axially oriented travel position and an off-axis operative position; and
a grapple arm supported by the vehicle, the grapple arm being capable of feeding logs into the wood chipper when the wood chipper is positioned in the off-axis operative position.

2. The mobile wood chipper of claim 1, further comprising means for locking the wood chipper at various degrees of rotation between an axially oriented travel position and an off-axis operative position.

3. The mobile wood chipper of claim 1, wherein the wood chipper is capable of rotating 360 degrees.

4. The mobile wood chipper of claim 1, further comprising means for rotating the wood chipper.

5. The mobile wood chipper of claim 4, wherein the means for rotating the wood chipper is a hydraulic motor.

6. The mobile wood chipper of claim 4, wherein the means for rotating the wood chipper is the grapple arm.

7. A mobile wood chipper, comprising:
a vehicle having a longitudinal axis and ground engaging wheels;
a rotary bearing supported by the vehicle;
a wood chipper mounted to the rotary bearing for rotation about a substantially vertical axis between an axially oriented travel position and an off-axis operative position;
a grapple arm supported by the vehicle, the grapple arm being capable of feeding logs into the wood chipper when the wood chipper is positioned in the off-axis operative position; and
means for locking the wood chipper at various degrees of rotation between an axially oriented travel position and an off-axis operative position

8. The mobile wood chipper of claim 7, wherein the wood chipper is capable of rotating 360 degrees.

9. The mobile wood chipper of claim 7, further comprising means for rotating the wood chipper.

10. The mobile wood chipper of claim 9, wherein the means for rotating the wood chipper is a hydraulic motor.

11. The mobile wood chipper of claim 9, wherein the means for rotating the wood chipper is the grapple arm.

12. A mobile wood chipper, comprising:
a vehicle having a longitudinal axis and ground engaging wheels;
a rotary bearing supported by the vehicle;
a wood chipper mounted to the rotary bearing for rotation about a substantially vertical axis between an axially oriented travel position and an off-axis operative position;
a grapple arm supported by the vehicle, the grapple arm being capable of feeding logs into the wood chipper when the wood chipper is positioned in the off-axis operative position; wherein the wood chipper is capable of rotating 360 degrees;
means for locking the wood chipper at various degrees of rotation between an axially oriented travel position and an off-axis operative position; and
means for rotating the wood chipper.

13. The mobile wood chipper of claim 12, wherein the means for rotating the wood chipper is a hydraulic motor.

14. The mobile wood chipper of claim 12, wherein the means for rotating the wood chipper is the grapple arm.
